(19) United States
(12) Patent Application Publication
(10) Pub. No.: US 2014/0329939 A1
(43) Pub. Date: Nov. 6, 2014

(54) GRAFT POLYMER, AND THERMOREVERSIBLY CROSS-LINKED BITUMEN/POLYMER COMPOSITION CONTAINING SUCH A GRAFT POLYMER

(71) Applicants: TOTAL MARKETING SERVICES, Puteaux (FR); CENTRE NATIONAL DE LA RECHERCHE SCIENTIFIQUE (CNRS), Paris (FR)

(72) Inventors: Ilias Iliopoulos, Paris (FR); Ludwik Leibler, Paris (FR); Ornella Annabelle Zovi, Coulon (FR); Carole Ruot, Irigny (FR)

(73) Assignees: TOTAL MARKETING SERVICES, Puteaux (FR); CENTRE NATIONAL DE LA RECHERCHE SCIENTIFIQUE (CNRS), Paris (FR)

(21) Appl. No.: 14/366,448

(22) PCT Filed: Dec. 20, 2012
(86) PCT No.: PCT/EP2012/076295

§ 371 Date: Jun. 18, 2014

(30) Foreign Application Priority Data
Dec. 20, 2011 (FR) 1161984

(51) Int. Cl. C08G 75/00; C08L 95/00

(52) U.S. Cl. CPC C08G 75/00; C08L 95/00
USPC 524/68; 525/332.9; 525/54.5

(57) ABSTRACT

A thermoreversibly cross-linked graft polymer, which may be used in bituminous asphalt, includes: a main polymer chain P consisting of conjugated diene units; at least one side graft G having the following general formula (1): R—(OCH₂CH₂)ₘ—S—, where R is a straight or branched saturated hydrocarbon chain having at least 18 carbon atoms, and m is an integer varying from 0 to 20, the graft G being connected to the main polymer chain P via the sulfur atom of formula (1); and at least one graft G′ having the following general formula (4): —S—R′—S—, where R′ is a linear or branched, saturated or unsaturated hydrocarbon grouping having from 2 to 40 carbon atoms, optionally including one or more heteroatoms, the graft G′ being connected to the main polymer chain P via each sulfur atom of formula (4).

### CROSS-REFERENCE TO RELATED APPLICATIONS

This application is a National Phase Entry of International Application No. PCT/EP2012/076295, filed on Dec. 20, 2012, which claims priority to French Patent Application Serial No. 1161984, filed on Dec. 20, 2011, both of which are incorporated by reference herein.

### TECHNICAL FIELD

The present invention relates to a graft polymer, its method of preparation and the use of said polymer to prepare a thermoreversibly cross-linked bitumen/polymer composition. The present invention also concerns a thermoreversibly cross-linked bitumen/polymer composition containing said graft polymer, its preparation method and an asphalt mix including such a composition.

### BACKGROUND

Bitumen is a binder which has long been used for different applications, in particular in the field of road building or civil engineering. It is known that adding of a thermoplastic polymer to bitumen improves the rheological properties of the bitumen, in particular elastic properties and cohesiveness thereby broadening the field of application of bitumen/polymer compositions. Thermoplastic polymers fluidify and become malleable under the effect of heat, in reversible manner. During the preparation process of the modified binder, modification of the bitumen is obtained either by mere physical mixing of the bitumen and polymer or by a chemical cross-linking reaction. In this latter case, the reaction is irreversible. Once cross-linking has been carried out it is not possible to return to the initial state existing before the cross-linking reaction. Cross-linked bitumen/polymer compositions therefore have good mechanical properties but their viscosity is very high. Depending on the intended applications, it is necessary to find a good compromise between the mechanical properties and the fluidity of the cross-linked bitumen/polymer compositions.

Cross-linking operations in the prior art are mostly irreversible cross-links based on the formation of covalent bonds between the polymer chains. For example one of the cross-links most used in the field of bitumens is sulfur cross-linking or vulcanisation. As examples, it can be mention in particular the patents FR-A-2376188, EP-A-0799280 and EP-A-0690892.

Novel thermoreversibly cross-linked polymers have recently been developed. Most of these thermoreversible cross-links are performed via thermoreversible covalent bonds. There also exists thermoreversible cross-linking via coordination bonds or ionic bonds.

For example, JP-A-11106578 describes the modification of a polyolefin by an acid anhydride which reacts in the presence of alcohols to form thermoreversible ester bonds. EP-A-870793 describes a mixture of a first polymer having at least two acid functions and a second polymer having at least two amine functions so as to form amide groups that are stable at low temperature and separable at high temperature. FR-A-2558845 describes the reaction between a divinyl-ether and a copolymer carrying acid functions. The acyl obtained is stable at low temperature and decomposes when the temperature is raised. Other thermoreversibly cross-linked polymers involve polymers comprising carboxylic acid units which bind reversibly to metals (JP-A-50139135, JP-A-51019035, JP-A-56014573). Others have recourse to labile ionic bonds between acid and amine groups (JP-A-52065549, JP-A-57158275).

Recently, the Applicant company has developed novel thermoreversibly cross-linked bitumen/polymer compositions from a new family of graft polymers (WO09/030840 and WO09/030841). At temperatures of use the bitumen/polymer compositions obtained exhibit the properties of conventionally cross-linked bitumen/polymer compositions, and at preparation temperatures they exhibit the properties of non-cross-linked bitumen/polymer compositions.

### SUMMARY

The objective of the present invention is to improve the rheological properties, in particular mechanical and elastic properties, and the cohesiveness of thermoreversibly cross-linked bitumen/polymer compositions described in applications WO09/030840 and WO09/030841 of the Applicant. Under these circumstances, the present invention aims to obtain polymers which can be thermoreversibly cross-linked in an organic medium e.g. in bitumen, these polymers able to be used in bitumen/polymer compositions which themselves are to be thermoreversibly cross-linked. In particular, the present invention aims to propose graft polymers which impart improved rheological properties to bitumen/polymer compositions whilst maintaining a thermoreversible effect. A further objective of the invention is to propose a method for preparing graft polymers that is efficient, simple to implement and economically viable. A further objective of the invention is to propose bitumen/polymer compositions which at temperatures of use exhibit the properties of irreversibly cross-linked bitumen/polymer compositions, particularly regarding elasticity and/or cohesiveness, and which at temperatures of preparation exhibit a reduced viscosity.

In the continuation of its research work, the Applicant company has developed novel thermoreversibly cross-linked bitumen/polymer compositions from a new family of graft polymers. The bitumen/polymer compositions obtained exhibit the properties of conventionally cross-linked bitumen/polymer compositions at temperatures of use and exhibit the properties of non-cross-linked bitumen/polymer compositions at temperatures of preparation. In addition, the Applicant proposes a novel method for preparing the graft polymers according to the invention.

According to the invention, the objective of the invention is reached with a thermoreversibly cross-linked graft polymer comprising:

a main polymer chain P containing conjugated diene units;

at least one side graft G represented by the following general formula (1):

R—(OCH₂CH₂)ₘ—S— (1)

where R is a saturated, linear or branched hydrocarbon chain having at least 18 carbon atoms and m is an integer varying from 0 to 20, the said graft G being linked to the main polymer chain P via the sulfur atom of formula (1); and

at least one graft G′ represented by the following general formula (4):

—S—R′—S— (4)

where R′ is a hydrocarbon group, saturated or unsaturated, linear or branched, cyclic and/or aromatic, having from 2 to 40 carbon atoms, optionally comprising one or more heteroatoms, the said graft G′ being linked to the main polymer chain P via each of the sulphur atoms of formula (4).

According to one particular embodiment, the graft G is represented by the following general formula (2):

CₙH₂ₙ₊₁—S— (2)

where n is an integer varying from 18 to 110.

According to another particular embodiment, the graft G is represented by the following general formula (3):

CₙH₂ₙ₊₁—(OCH₂CH₂)ₘ—S— (3)

where n is an integer varying from 18 to 110 and m is an integer varying from 1 to 20.

According to one preferred embodiment, the graft G′ is represented by the following general formula (5):

—S—C_{n′}H_{2n′}—S— (5)

where n′ is an integer varying from 2 to 40.

According to the invention, the objective of the invention is also reached with a method for preparing a graft polymer according to the invention comprising a grafting reaction of at least one thiol compound and at least one dithiol compound on reactive double bonds of a polymer containing conjugated diene units, the said thiol compound being represented by the following formula (6):

R—(OCH₂CH₂)ₘ—SH (6)

where R is a saturated, linear or branched hydrocarbon chain of at least 18 carbon atoms and m is an integer varying from 0 to 20;

the said dithiol compound being represented by the following general formula (9):

HS—R′—SH (9)

where R′ is a hydrocarbon group, saturated or unsaturated, linear or branched, cyclic and/or aromatic, having from 2 to 40 carbon atoms, optionally comprising one or more heteroatoms.

According to one particular embodiment, the thiol compound is represented by the following general formula (7):

CₙH₂ₙ₊₁—SH (7)

where n is an integer varying from 18 to 110.

According to one particular embodiment, the thiol compound is represented by the following general formula (8):

CₙH₂ₙ₊₁—(OCH₂CH₂)ₘ—SH (8)

where n is an integer varying from 18 to 110 and m is an integer varying from 1 to 20.

According to another particular embodiment, the dithiol compound is represented by the following general formula (10):

HS—C_{n′}H_{2n′}—SH (10)

where n′ is an integer varying from 2 to 40.

According to one particular development, the molar ratio denoted R_{thiol/dithiol} between the thiol compound and the dithiol compound is comprised between 10:1 and 800:1. According to another particular development, the reactive double bonds are pendant vinyl double bonds derived from a 1-2 addition of the conjugated diene units. Preferably, the polymer containing conjugated diene units has a weight content of units with pendant vinyl double bonds after the 1-2 addition comprised between 5% and 80% relative to the said polymer. Preferably, the molar ratio denoted R_{thio/vinyl} between the thiol compound and the unit with pendant vinyl double bonds derived from the 1-2 addition is comprised between 1:10 and 10:1. Preferably, the polymer containing conjugated diene units results from the copolymerization of conjugated diene units and aromatic monovinyl hydrocarbon units.

According to one preferred embodiment, the method for preparing a graft polymer according to the invention comprises the following successive steps:
(i) the thiol compound, dithiol compound and polymer containing conjugated diene units are mixed at a temperature comprised between 20° C. and 120° C., for a time of 10 minutes to 24 hours, the said mixture being devoid of solvent or radical initiator;
(ii) the mixture is brought to a temperature comprised between 80° C. and 200° C. for a time of 10 minutes to 48 hours.

The invention concerns the use of a graft polymer according to the invention to prepare a thermoreversibly cross-linked bitumen/polymer composition. The invention also concerns a thermoreversibly cross-linked bitumen/polymer composition comprising at least one bitumen and at least one graft polymer according to the invention. According to one particular embodiment, the weight content of graft polymer relative to the bitumen in the bitumen/polymer composition is comprised between 0.1 and 30%, preferably between 1 and 10%.

A further subject of the invention is a method for preparing a bitumen/polymer composition according to the invention which comprises the mixing of at least one bitumen and at least one graft polymer according to the invention, at a temperature comprised between 100° C. and 200° C. until the final thermoreversibly cross-linked bitumen/polymer composition is obtained. Finally a further subject of the invention is an asphalt mix comprising aggregates and a bitumen/polymer composition according to the invention.

### DETAILED DESCRIPTION

According to one particular embodiment, the thermoreversibly cross-linked graft polymer according to the invention is a graft polymer comprising a main polymer chain P containing conjugated diene units, at least one side graft G and at least one graft G′. By main polymer chain P containing conjugated diene units is meant the main polymer chain obtained by polymerization of several monomers, at least one of said monomers being a monomer containing a conjugated diene unit so as to form reactive double bonds on which compounds have been grafted to form the grafts G and G′.

The main polymer chain P is therefore chiefly post-functionalized via the reactive double bonds so as to form a side graft G and a cross-linking graft G′ according to the following structures:

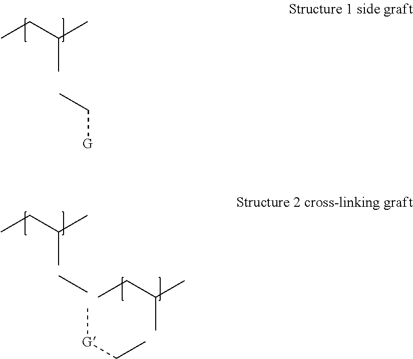

The main polymer chain P (in bold on structures 1 and 2) comprises hydrocarbon units (between brackets on structures 1 and 2) linked to the side graft G and/or to the graft G′.

The side graft G is represented by the following general formula (1):

R—(OCH₂CH₂)ₘ—S (1)

where:

R is a saturated, linear or branched hydrocarbon chain having at least 18 carbon atoms, preferably at least 22 carbon atoms, more preferably at least 30 carbon atoms and further preferably at least 40 carbon atoms; and

m is an integer varying from 0 to 20.

The side graft G is linked to the main polymer chain P by the sulfur atom of formula (1). Therefore, the side graft G is linked to the main polymer chain P via a carbon-sulfur bond (bond shown as a dotted line in formula 1 and on structure 1). The saturated hydrocarbon chain of the graft G is advantageously a linear chain.

The side graft G may solely contain a saturated hydrocarbon chain. In this case the side graft G is preferably represented by the following general formula (2):

CₙH₂ₙ₊₁—S— (2)

where n is an integer varying from 18 to 110, preferably varying from 18 to 90, more preferably from 18 to 70, further preferably from 18 to 40 and still further preferably from 26 to 40.

Alternatively, the side graft G may contain an ethoxylated chain. In this case the side graft G is represented by formula (1) wherein m is an integer varying from 1 to 20, preferably from 1 to 10, more preferably from 2 to 10 and further preferably from 2 to 4.

The side graft G is advantageously represented by the following general formula (3):

CₙH₂ₙ₊₁—(OCH₂CH₂)ₘ—S— (3)

where:

n is an integer varying from 18 to 110, preferably varying from 18 to 90, more preferably from 18 to 70, further preferably from 18 to 40 and still further preferably from 26 to 40; and

m is an integer varying from 1 to 20, preferably from 1 to 10, more preferably from 2 to 10, further preferably from 2 to 4.

The mean number of grafts G per main polymer chain P is higher than 2, preferably higher than 50, more preferably higher than 100, further preferably higher than 400.

The graft G′ is represented by the following general formula (4):

—S—R′—S— (4)

where R′ is a hydrocarbon group, saturated or unsaturated, linear or branched, cyclic and/or aromatic, having from 2 to 40 carbon atoms, preferably from 4 to 20, more preferably from 6 to 18 and further preferably from 8 to 14. The graft G′ is linked to one or two main polymer chains P by the sulfur atoms of formula (4). Therefore the graft G′ is linked to one or two main polymer chains P via two carbon-sulfur bonds (dotted bonds on structure 2 and in the formula 4). The graft G′ can be linked to a main polymer chain P by the two sulfur atoms of the formula (4) or can be linked to two main polymer chains P via one of the two sulfur atoms of formula (4) respectively.

The hydrocarbon group R′ may comprise at least one aromatic core, preferably at least two aromatic cores. According to one preferred particular embodiment, R′ is a hydrocarbon group, saturated or unsaturated, linear or branched, having from 2 to 40 carbon atoms, preferably from 4 to 20, more preferably from 6 to 18 and further preferably from 8 to 14. The hydrocarbon group R′ is advantageously saturated and linear.

In particular the graft G′ is represented by the following general formula (5):

—S—C_{n′}H_{2n′}—S— (5)

where n′ is an integer varying from 2 to 40, preferably from 4 to 20, more preferably from 6 to 18 and further preferably from 8 to 14.

According to one particular embodiment, the graft G′ may optionally comprise one or more heteroatoms. In this case, the graft G′ is preferably free of any carbonyl function C═O and/or carboxylate function O—C═O. The graft G′ advantageously comprises one or more heteroatoms chosen from among oxygen, sulfur and nitrogen. The graft G′ preferably comprises one or more oxygen atoms.

According to one particular embodiment, the thermoreversibly cross-linked graft polymer of the invention advantageously results from a post-functionalization of a polymer containing conjugated diene units having reactive double bonds. By post-functionalization is meant the obtaining of grafting of the polymer after polymerization of its constituent monomers, to form the grafts G and G′ on the main polymer chain P. The graft polymer is therefore obtained by polymerization followed by grafting and not by polymerization of monomers already functionalized by the grafts G and G′.

A method for preparing the graft polymer comprises a grafting reaction of at least one thiol compound (mercaptan) and at least one dithiol compound (di-mercaptan) on reactive double bonds of a polymer containing conjugated diene units. By polymer containing conjugated diene units is meant a polymer obtained from at least one conjugated diene unit. Therefore the polymer containing conjugated diene units may result from homo-polymerization solely of diene units, preferably conjugated diene units. The polymer containing conjugated diene units may, along the polymer chain, comprise several double bonds resulting from homo-polymerization of the diene units, preferably conjugated diene units. Such polymers are polybutadienes, polyisoprenes, polyisobutenes, polychloroprenes for example, but also butyl rubbers obtained by concatenation of copolymers of isobutene and isoprene. It is also possible to use copolymers or terpolymers obtained from diene units such as butadiene, isoprene, isobutene, 2,3-dimethyl-1,3-butadiene, 1,3-pentadiene, 1,3-hexadiene, chloroprene, carboxylated butadiene or carboxylated isoprene units.

The polymer containing conjugated diene units may also result from copolymerization or terpolymerization of diene units, preferably conjugated diene, and other units containing other reactive functions. These reactive functions can be chosen for example from among double bonds, epoxides, acid anhydrides, carboxylic acids, esters, amides, thiols, alcohols and amines, preferably from double bonds. Therefore the polymer containing conjugated diene units can be obtained from diene units, preferably conjugated diene, and from units such as units of vinyl acetate, methyl acrylate, butyl acrylate, maleic anhydride, glycidyl metacrylate, glycidyl acrylate and norbornene.

The polymer containing conjugated diene units is chosen for example from among ethylene/propene/diene (EPDM) terpolymers and acrylonitrile/butadiene/styrene (ABS) terpolymers. The polymer containing conjugated diene units may optionally have undergone one or more treatments after polymerization e.g. a partial hydrogenation. The preferred polymers containing conjugated diene units are the polymers resulting from copolymerization of conjugated diene units and aromatic monovinyl hydrocarbon units.

The conjugated diene unit is preferably chosen from among the diene units comprising from 4 to 8 carbon atoms per monomer, such as butadiene, 2-methyl-1,3-butadiene (isoprene), 2,3-dimethyl-1,3-butadiene, 1,3-pentadiene and 1,3-hexadiene, chloroprene, carboxylated butadiene or carboxylated isoprene. The conjugated diene unit is advantageously the butadiene unit.

The aromatic monovinyl hydrocarbon unit is preferably chosen from among styrene, o-methyl styrene, p-methyl styrene, p-tert-butylstyrene, 2,3-dimethyl-styrene, alpha-methyl styrene, vinyl naphthalene, vinyl toluene, vinyl xylene. The aromatic monovinyl hydrocarbon unit is advantageously the styrene unit.

The reactive double bonds of the polymer containing conjugated diene units are of two types as a function of the 1-2 or 1-4 addition of conjugated diene units during the polymerization of the said polymer. The double bonds derived from 1-2 addition of conjugated dienes are pendant vinyl double bonds. The reactive double bonds are preferably pendant vinyl double bonds derived from 1-2 addition of conjugated diene units. The polymer containing conjugated diene units preferably has a weight content of units with pendant vinyl double bonds derived from 1-2 addition comprised between 5% and 80% relative to the said polymer.

According to one particular preferred embodiment the polymer containing conjugated diene units is a block copolymer containing styrene and butadiene. The reactive functions present on the said polymer after the polymerization reaction are pendant vinyl double bonds derived from the 1-2 addition of butadiene units. Nonetheless, the double bonds derived from 1-4 addition of butadiene units although less reactive may also take part in the grafting reaction.

The polymer containing conjugated diene units advantageously has a weight content of styrene ranging from 5% to 50% and a weight content of butadiene ranging from 50% to 95% relative to the said polymer. The polymer containing conjugated diene units preferably has a weight content of units with pendant vinyl double bonds derived from 1-2 addition of butadiene ranging from 5% to 80% relative to the said polymer. The weight average molecular weight of the polymer containing conjugated diene units may be comprised between 10 000 and 600 000 daltons for example, preferably between 30 000 and 400 000 daltons. The graft polymer is obtained by reaction between the double bonds of the polymer containing conjugated diene units, in particular the pendant vinyl double bonds derived from 1-2 addition of the conjugated dienes, and the thiol functions of the thiol compound and the dithiol compound so as to form carbon-sulfur bonds (dotted bonds in structures on 1 and 2).

The thiol compound is represented by the following general formula (6):

R—(OCH₂CH₂)ₘ—SH (6)

where:

R is a saturated, linear or branched hydrocarbon chain of at least 18 carbon atoms, preferably at least 22 carbon atoms, more preferably at least 30 carbon atoms, further preferably at least 40 carbon atoms; and,

m is an integer varying from 0 to 20.

R is preferably a saturated, linear hydrocarbon chain.

The thiol compound may solely contain a saturated hydrocarbon chain. In this case, the thiol compound is preferably represented by the following general formula (7):

CₙH₂ₙ₊₁—SH (7)

where n is an integer varying from 18 to 110, preferably varying from 18 to 90, more preferably from 18 to 70, further preferably from 18 to 40 and still further preferably from 26 to 40.

The thiol compound can be chosen from among the following thiols: C₁₈H₃₇—SH, C₄₀H₈₁—SH, C₇₀H₁₄₁—SH and/or C₉₀H₁₈₁—SH. According to one variant, the thiol compound may contain an ethoxylated chain. In this case, the thiol compound is represented by formula (6) in which m is an integer varying from 1 to 20, preferably from 1 to 10, more preferably from 2 to 10 and further preferably from 2 to 4.

The thiol compound is advantageously represented by the following general formula (8):

CₙH₂ₙ₊₁—(OCH₂CH₂)ₘ—SH (8)

where:

n is an integer varying from 18 to 110, preferably varying from 18 to 90, more preferably from 18 to 70, further preferably from 18 to 40 and still further preferably from 26 to 40; and

m is an integer varying from 1 to 20, preferably from 1 to 10, more preferably from 2 to 10 and further preferably from 2 to 4.

The dithiol compound is preferably represented by the following general formula (9):

HS—R′—SH (9)

where R′ is a hydrocarbon group, saturated or unsaturated, linear or branched, cyclic and/or aromatic, having from 2 to 40 carbon atoms, preferably from 4 to 20, more preferably from 6 to 18, further preferably from 8 to 14. The hydrocarbon group R′ of the dithiol compound may comprise at least one aromatic core, preferably at least two aromatic cores. According to one particular preferred embodiment, R′ is a hydrocarbon group, saturated or unsaturated, linear or branched, neither cyclic nor aromatic, having from 2 to 40 carbon atoms, preferably from 4 to 20, more preferably from 6 to 18 and further preferably from 8 to 14.

The hydrocarbon group R′ of the dithiol compound is advantageously saturated and linear. In particular, the dithiol compound is represented by the following general formula (10):

HS—C_{n′}H_{2n′}—SH (10)

where n′ is an integer varying from 2 to 40, preferably from 4 to 20, more preferably from 6 to 18, further preferably from 8 to 14.

According to one particular embodiment, the dithiol compound may optionally comprise one or more heteroatoms. In this case, the dithiol compound is preferably free of any carbonyl function C═O and/or carboxylate function O—C═O. The dithiol compound advantageously comprises one or more heteroatoms selected from oxygen, sulfur and nitrogen. The dithiol compound preferably comprises one or more oxygen atoms.

The molar ratio denoted R_{thiol/dithiol} between the thiol compound and the dithiol compound is comprised between 10:1 and 800:1, preferably between 50:1 and 500:1, more preferably between 100:1 and 400:1. The molar ratio denoted R_{thio/vinyl} between the thiol compound and the unit with pendant vinyl double bonds derived from 1-2 addition is comprised between 1:10 and 10:1, preferably between 1:5 and 5:1, more preferably between 1:2 and 2:1.

According to one particular preferred embodiment, the method for preparing a graft polymer is conducted in the absence of a solvent and radical initiator. In particular, the method is characterized by two successive reaction steps. At the first step the pre-mixing is performed of the polymer containing conjugated diene units, the thiol compound and the dithiol compound under mild conditions, the said polymers, thiol compound and dithiol compound being such as described above. At the second step the grafting reaction properly so-called is carried out i.e. the reaction between the polymer containing conjugated diene units and the thiol and dithiol compounds to form grafts, respectively side graft G and graft G′, on the main polymer chain P of the said polymer.

The method for preparing the graft polymer particularly comprises the following successive steps:
(i) the thiol compound, the dithiol compound and the polymer containing conjugated diene units are mixed at a temperature comprised between 20° C. and 120° C., for a time of 10 minutes to 24 hours, the said mixture being devoid of solvent and radical initiator,
(ii) the mixture is brought to a temperature comprised between 80° C. and 200° C. for a time of 10 minutes to 48 hours.

At step (i), the thiol compound and the dithiol compound can be contacted with the polymer and mixed using any known method, simultaneously or successively in any order. Nonetheless, it is preferred to place the thiol and dithiol compounds simultaneously in contact with the polymer containing conjugated diene units. The temperature at step (i) is preferably comprised between 30° C. and 110° C., preferably 40° C. and 100° C., more preferably between 50° C. and 90° C., further preferably between 50° C. and 80° C.

Advantageously, thiol and dithiol compounds are chosen to melt at the temperature of step (i), to promote swelling of the polymer containing conjugated diene units. The thiol and dithiol compounds, liquid at these temperatures, act as solvent of the said polymer and allow avoiding of the use of a solvent.

According to one variant, step (i) may comprise two separate sub-steps, a first sub-step intended to melt the thiol and dithiol compounds, then a second sub-step intended to swell the polymer in the molten thiol and dithiol compounds. The temperature at step (i) may be applied for example with a first temperature rise up to a first hold fixed at a temperature comprised between 40° C. and 60° C. for sufficient time to melt the thiol and dithiol compounds, followed by a second temperature rise up to a second hold at a temperature comprised between 60° C. and 110° C. for sufficient time to obtain optimal swelling of the polymer. For thiol and dithiol compounds that are non-liquid at the temperature of step (i), homogenizing means of the solid mixture are advantageously used, for example a mixer or extruder.

Alternatively, an organic solvent can be added to the polymer to cause the polymer to swell and promote solubilisation of the thiol and dithiol compounds in the polymer, provided that this organic solvent is entirely evaporated before the second step (ii). Therefore, the mixture is devoid of solvent and radical initiator after step (i). For example toluene can be chosen, or xylene, chloroform, dichloromethane, alkanes such as dodecane or any other solvent or mixture of usual solvents. The maximum amount of added solvent is 10% by weight relative to the polymer/thiol/dithiol mixture, preferably 5%, more preferably 3%, further preferably 1%.

The duration of step (i) is preferably comprised between 30 minutes and 12 hours, more preferably between 1 hour and 10 hours, further preferably between 2 hours and 8 hours, still further preferably between 4 hours and 6 hours. The lengths of time are longer if no agitation is provided. The second step does not require the use of a radical initiator. Secondary parasitic coupling reactions and chain rupture due to the presence of a radical initiator are therefore strongly limited.

The temperature at step (ii) is preferably comprised between 100° C. and 160° C., more preferably between 100° C. and 140° C. The length of step (ii) is advantageously comprised between 30 minutes and 72 hours, preferably between 1 hour and 24 hours, more preferably between 2 hours and 24 hours, further preferably between 4 hours and 24 hours. For steps (i) and (ii) an inert atmosphere can be used such as nitrogen or argon, with or without mechanical agitation. Preferably steps (i) and (ii) are conducted under agitation to improve the yield of the grafting reaction.

At the end of the second grafting step (ii), the graft polymer is advantageously purified using any known process. The method preferably comprises a subsequent purification step e.g. by precipitation in a suitable solvent or mixture of solvents followed by filtering and drying. The solvent(s) are selected in accordance with well-known principles of solubility. For example methanol is used for precipitation.

In addition, an anti-oxidizing agent such as 2,6-di-tert-butyl-4-methylphenol can be added to the graft polymer obtained using the above-described preparation method. In particular the anti-oxidizing agent can be added to the solvent used for the precipitation step.

A grafting yield is defined as corresponding to the amount of grafted thiol and dithiol compounds relative to the amount of starting thiol and dithiol compounds. The grafting yields are advantageously comprised between 10 and 99%, preferably between 20 and 90%, more preferably between 30 and 80%, further preferably between 40 and 70%.

According to another particular embodiment, the method for preparing the graft polymer is performed in the presence of a solvent and/or catalyst and/or radical initiator using any known process. The method for preparing the graft polymer may comprise the grafting of several thiol compounds and/or several dithiol compounds, thereby forming a graft polymer containing several side grafts G of different chemical structures and/or several grafts G′ of different chemical structures. Therefore, within one same main polymer chain P, side grafts G may having different chain lengths co-exist.

The thermoreversible cross-linking of the graft polymer may theoretically result from the assembling of the graft polymers via the side grafts G (more specifically via the hydrocarbon chains of the grafts G). This assembling allows the defining of crystalline regions between the side grafts G of the graft polymer. These crystalline regions are stable at low temperature. When the temperature increases, these crystalline regions melt and they re-crystallize when the temperature is decreased. At low temperature, the interactions of the crystalline regions of the grafts G draw together the chains of the graft polymer which are then cross-linked. When the crystalline regions of the grafts melt, the chains of the graft polymer draw apart, they are no longer cross-linked. Therefore it would seem that the nature of graft G, in particular the length of the side chain of G, has an effect on the thermoreversible crosslinking of the graft polymer.

The graft G′ draws together the main polymer chains P and structures the graft polymer. Surprisingly, the combination of a side graft G and of a graft G′ imparts remarkable mechanical properties to the graft polymer, in particular excellent cohesion.

The above-described graft polymer may advantageously be used to prepare a thermoreversibly cross-linked bitumen/polymer composition. In particular, the graft polymer can be used as additive for bitumen or a bituminous composition. Therefore when bitumen is added to this graft polymer, a bitumen/polymer composition is obtained which is reversibly cross-linked and more particularly thermoreversibly, and which has improved mechanical properties in particular regarding penetration value and Ring and Ball softening Temperature (RBT). The graft polymer imparts thermoreversible properties to the bitumen/polymer composition that are comparable to those of a bitumen/polymer composition grafted solely with a graft G.

By thermoreversible crosslinking of the bitumen/polymer compositions according to the invention is meant cross-linking which translates into the following phenomena:

at low temperature for example at duty temperatures, the grafts G and G′ of the graft polymer are associated together and form crosslinking points. The formed polymer network imparts good mechanical properties to the bitumen/polymer composition, in particular in respect of elasticity, cohesion, penetrability and Ring and Ball Temperature (RBT);

an increase in temperature causes rupture of the cross-linking points and hence separation of the polymer chains. The polymer network disappears and the bitumen/polymer composition recovers low viscosity and hence good fluidity, which allows handling at a lower temperature.

A decrease in temperature allows the cross-linking points to re-form. The phenomenon is thermoreversible.

The bitumen/polymer composition of the invention comprises at least one bitumen and at least one graft polymer such as described above. In addition, the bitumen/polymer composition may comprise at least one fluxing agent. The weight content of graft polymer relative to the bitumen is comprised between 0.1 and 30%, preferably between 1 and 10%, more preferably between 2 and 6%. The bitumen/polymer composition may contain a bitumen or mixture of bitumens from different origins. Mention is first made of bitumen of natural origin, those contained in deposits of natural bitumen, natural asphalt or bituminous sand.

The bitumens may also be selected from those derived from the refining of crude oil. They are derived from the atmospheric and/or vacuum distillation of petroleum. These bitumens may optionally be blown-bitumen, viscosity-cutback and/or de-asphalted bitumen. They may be of hard or soft grade. The different bitumens obtained with refining processes can be combined of them to obtain the best technical compromise.

The bitumens used may also be fluxed bitumens by the addition of volatile solvents, fluxing agents of petroleum origin, carbo-chemical fluxes and/or fluxes of vegetable origin. The fluxing agents used may comprise C₆ to C₂₄ fatty acids in acid, ester or amide form in combination with a hydrocarbon cut. The bitumen/polymer compositions can be prepared using any known process.

According to one particular embodiment, a method for preparing bitumen/polymer compositions as described in the foregoing comprises the mixing of at least one bitumen and at least one above-described graft polymer, at a temperature comprised between 90° C. and 220° C. until the final thermoreversibly cross-linked bitumen/polymer composition is obtained. In particular, the method for preparing these bitumen/polymer compositions comprises the following essential steps:

a) a bitumen is introduced in a vessel equipped with mixing means, and the bitumen is brought to a temperature comprised between 90 and 220° C., preferably between 140° C. and 180° C.;

b) 0.1 to 30% by weight of a graft polymer according to the invention relative to the weight of bitumen is added, preferably 0.1 to 10%.

Throughout the method, the composition is heated to a temperature comprised between 90 and 220° C., preferably between 140 and 180° C., under agitation, until a homogeneous final bitumen/polymer composition is obtained.

Various uses of the bitumen/polymer compositions obtained according to the invention are envisaged, in particular for the manufacture of a bituminous binder which in turn can be used to prepare an association with aggregate to form bituminous mixes in particular for road paving. The bituminous binder may be under anhydrous form, emulsion form or under the form of fluxed bitumen. Another aspect of the invention is the use of the above-described bitumen/polymer compositions in various industrial applications, in particular to manufacture sealed coatings, an impregnating membrane or layer, sound-proofing membranes, insulating membranes, surface coatings, carpet tiles, etc.

With respect to road applications of these bitumen/polymer compositions, the invention particularly concerns bituminous mixes for road building and the maintaining of road base courses and surfaces, and for all road works. For example, the invention therefore concerns surface dressings, hot mixes, cold mixes, micro paving cold mix asphalt and grave emulsions. According to one particular embodiment, a bituminous mix comprises aggregate and a bitumen/polymer composition according to the invention. The bitumen/polymer compositions can be used to form base courses, binder courses, tack coats, wearing courses, anti-rutting layers, draining asphalt, mastic asphalt (mixture of a bituminous binder and sand-type aggregate). Although the present invention solely describes applications in the field of bitumens, the graft polymer may be used in other applications in which the mechanical and thermoreversible properties thereof can be given advantageous use.

### Examples

### Preparation of the Graft Polymers

Graft polymers PG₁, PG₂ and PG₃ are prepared from:

a styrene/butadiene diblock copolymer SB₀ with random junction point and having a weight average molecular weight M_{w} equal to 120 000 g·mol⁻¹, a number average molecular weight Mₙ equal to 115 000 g·mol⁻¹, and 23% by weight of styrene relative to the weight of the copolymer of which 18% in block form, and 77% by weight of butadiene relative to the weight of the copolymer, the weight percent of units with 1-2 double bonds (pendant vinyl bonds) derived from butadiene being 7% relative to the weight of the copolymer;

a styrene/butadiene diblock copolymer SB₁ with random junction point having a weight average molecular weight M_{w} equal to 130 000 g·mol⁻¹, a number average molecular weight Mₙ equal to 125 000 g·mol⁻¹, 30% by weight of styrene relative to the weight of the copolymer of which 19% in block form and 70% by weight of butadiene relative to the weight of the copolymer, the weight percent of units with 1-2 double bonds derived from butadiene (pendant vinyl bonds) being 15% relative to the weight of the copolymer;

a thiol compound of formula C₁₈H₃₇—SH

a dithiol compound of formula HS—C₁₀H₂₀—SH

Preparation of Polymer PG₁ (According to the Invention)

A 2 L reactor equipped with mechanical agitator, a nitrogen inlet and outlet, is charged with 148.6 g of thiol compound (0.518 mol), 0.27 g of dithiol compound (1.295×10⁻³ mol) and 200 g of copolymer SB₀ (2.62 mol of butadiene of which 0.259 mol of pendant vinyl bond). The mixture is agitated at 50 rpm for 2 h at 50° C. under inert atmosphere. The temperature is increased to 110° C. The mixture is agitated at 50 rpm for 24 hours under inert atmosphere. Agitation is halted and the mixture is cooled to ambient temperature under inert atmosphere. A purification step is then performed whereby the mixture obtained is dissolved in toluene and the polymer PG₁ is precipitated with methanol. 1 L of the PG₁-containing solution is precipitated with 8 L of methanol, filtered and dried for 1 h at ambient temperature. The PG₁ copolymer is subsequently dissolved in toluene to obtain a 4 weight % solution and an antioxidant, BHT, is added in a proportion of 1/1000 by weight relative to the copolymer. The solution is poured into a Teflon mould and the solvent is left to evaporate at ambient temperature.

Preparation of Graft Polymer PG₂ (According to the Invention)

Procedure is similar to that followed for the graft polymer PG₁ with the exception that 0.53 g of the dithiol compound are used (2.59×10⁻³ mol).

Preparation of Graft Polymer PG₃ (According to the Invention)

Procedure is similar to that followed for graft polymer PG₁ with the exception that the amounts used are 158 g of thiol compound (0.56 mol), 1.15 g of dithiol compound (5.6×10⁻³ mol) and 200 g of copolymer SB₁ (2.59 mol of butadiene of which 0.56 mol of pendant vinyl bond).

Preparation of a Reference Graft Polymer PGₜ

The procedure followed is the same as for graft polymer PG₃ with the exception that no dithiol compound is used. The PGₜ polymer is solely functionalized with the thiol compound. The characteristics of the graft polymers obtained are given in following Table 1:

TABLE I

| Copolymer | SB₀ | SB₁ | PG₁ | PG₂ | PG₃ | PGₜ |
|---|---|---|---|---|---|---|
| Mₙ (Kg/mol) | 115 | 125 | 115 | 140 | 120 | 87 |
| M_{w} (Kg/mol) | 120 | 130 | 270 | 270 | 220 | 140 |
| I = M_{w} /Mₙ* | 1.04 | 1.04 | 2.4 | 1.9 | 1.8 | 1.61 |
| R_{thiol/vinyl} | — | — | 2:1 | 2:1 | 1:1 | 1:1 |
| R_{thiol/dithiol} | — | — | 400:1 | 200:1 | 100:1 | — |
| R_{thiol/dithiol/vinyl} | — | — | 400:1:200 | 200:1:100 | 100:1:100 | — |
| Graft molar %** | — | — | 8.8 | 9.3 | 11.3 | 12.3 |
| Graft yield (%)*** | — | — | 49 | 46 | 65 | 71 |

*Molar masses were determined by steric exclusion chromatography SEC or Gel Permeation Chromatography GPC at 40° C. with THF as eluent and using polystyrene for calibration.
**Grafting molar percentage was determined by ¹H NMR with Bruker 400 MHz spectrometer. Graft molar % expresses the proportion of a compound relative to all styrene/butadiene units.
***The graft yield corresponds to the fraction of grafted thiol relative to the initial amount of thiol.

Preparation of the Bitumen/Polymer Compositions

Bitumen/polymer compositions were prepared from grade 50/70 bitumen of penetration value 53 1/10 mm whose characteristics met standard EN 12591.

Bitumen/Polymer Compositions According to the Invention C₁, C₂ and C₃

Three bitumen/polymer compositions C₁, C₂ and C₃ according to the invention were prepared from the above-described graft polymers PG₁, PG₂ and PG₃ and bitumen. A reactor held at 180° C. and equipped with a mechanical agitator was charged with 35 g (95 weight %) of bitumen. The bitumen was heated to 185° C. and left under agitation for about 60 minutes. 1.85 g (5 weight %) of above-obtained graft polymer PG₁, PG₂ or PG₃ was added. Mixing was continued for a time of 4 hours under agitation. Bitumen/polymer compositions C₁, C₂ and C₃, were respectively obtained from the graft polymers PG₁, PG₂ and PG₃.

Reference Bitumen/Polymer Composition T₀

A reference bitumen/polymer composition, irreversibly cross-linked with sulfur (vulcanisation), is prepared. 35.5 g (94.87 weight %) of the above bitumen was placed in a reactor. The bitumen was heated to 185° C. and left under agitation 60 minutes at 300 rpm. 1.85 g (5 weight %) of copolymer SB₀ were added. The mixture was left under agitation and heated to 185° C. for about 4 hours. 50 mg (0.13 weight %) of sulfur flower were then added. The mixture was left under agitation and heated to 185° C. for 2 h.

Reference Bitumen/Polymer Composition T₁

A reference bitumen/polymer composition was prepared following the identical operating mode for compositions C₁, C₂ and C₃ from the graft polymer PGₜ. Table II below gives the physical characteristics of the compositions of the invention and of the reference composition.

TABLE II

| | C₁ | C₂ | C₃ | T₀ | T₁ |
|---|---|---|---|---|---|
| Penetrability (0.1 mm) ⁽¹⁾ | 46 | 41 | 39 | 36 | 50 |
| RBT (° C.) ⁽²⁾ | 57.6 | 63.4 | 59.8 | 64.2 | 54.4 |
| Viscosity at 80° C. ⁽³⁾ | 43.00 | 41.00 | 49.00 | 65.00 | 27.00 |
| (Pa · s) | | | | | |
| Viscosity at 100° C. ⁽³⁾ | 10.68 | 11.05 | 12.50 | 17.49 | 9.15 |
| ( Pa · s) | | | | | |
| Viscosity at 120° C. ⁽³⁾ | 2.70 | 2.73 | 3.12 | 4.80 | 2.30 |
| (Pa · s) | | | | | |
| Viscosity at 140° C. ⁽³⁾ | 0.97 | 0.98 | 1.05 | 1.61 | 0.81 |
| (Pa · s) | | | | | |
| Viscosity at 160° C. ⁽³⁾ | 0.43 | 0.43 | 0.46 | 0.69 | 0.36 |
| (Pa · s) | | | | | |
| Viscosity at 180° C. ⁽³⁾ | 0.23 | 0.23 | 0.24 | 0.34 | 0.19 |
| (Pa · s) | | | | | |
| Viscosity at 200° C. ⁽³⁾ | 0.14 | 0.14 | 0.14 | 0.20 | 0.11 |
| (Pa · s) | | | | | |
| Elongation max. at | >700 | >700 | >700 | >700 | >700 |
| 5° C. (%) (4) | | | | | |

⁽¹⁾ Penetration value as per standard EN 1426
⁽²⁾ Ring and Ball Temperature as per standard EN 1427
⁽³⁾ Dynamic viscosity, plane-plane, 25 mm at 100 s⁻¹
⁽⁴⁾ Tensile test as per standard EN 13587

The results of this Table show that the viscosities of the bitumen/polymer compositions according to the invention between 80° C. and 200° C. are always lower than those of the reference composition T₀. On and after 80° C., the bitumen/polymer compositions according to the invention are therefore less viscous than bitumen/polymer composition cross-linked with sulfur. At preparation temperatures the bitumen/polymer compositions according to the invention display low viscosity values. Also, the penetration values, RBT and maximum elongation are very close to those of the reference composition T₀. In comparison with composition T₁, the RBT and penetration values are better whilst maintaining low viscosity at temperatures of use comprised between 120° and 160° C.

The bitumen/polymer compositions of the invention are noteworthy in that they exhibit low viscosities at temperatures lower than those of the prior art whilst having good rheological properties. The use of the graft polymers of the invention in bitumen/polymer compositions has the further advantage of avoiding constraints related to the release of hydrogen sulfide (H₂S) during manufacture and/or transfer and/or loading and/or unloading and/or spreading of prior art bitumen/polymer compositions cross-linked with sulfur or sulfur derivatives. The use of the bitumen/polymer compositions of the invention to manufacture asphalt mixes allows the manufacturing temperature thereof to be lowered by about 10° C. whilst maintaining good mechanical properties, in particular penetration value and RBT of the bituminous mix.

1. A graft polymer comprising:
a main polymer chain P containing conjugated diene units;
at least one side graft G represented by the following general formula (1):
R—(OCH₂CH₂)ₘ—S— (1)
where R is a saturated linear or branched hydrocarbon chain, having at least 18 carbon atoms, and m is an integer varying from 0 to 20, the graft G being linked to the main polymer chain P via the sulfur atom of formula (1); and
at least one graft G′ represented by the following general formula (4):
—S—R′—S— (4)
where R′ represents a hydrocarbon group, saturated or unsaturated, linear or branched, cyclic and/or aromatic, having from 2 to 40 carbon atoms, the graft G′ being linked to the main polymer chain P by each of the sulfur atoms of formula (4).

2. The polymer according to claim 1, wherein the side graft G is represented by the following general formula (2):
CₙH₂ₙ₊₁—S— (2)
where n is an integer varying from 18 to 110.

3. The polymer according to claim 1, wherein the side graft G is represented by the following general formula (3):
CₙHₙ₊₁—(OCH₂CH₂)ₘ—S— (3)
where n is an integer varying from 18 to 110 and m is an integer varying from 1 to 20.

4. The polymer according to claim 1, wherein the graft G′ is represented by the following general formula (5):
—S—C_{n′}H_{2n′}—S— (5)
where n′ is an integer varying from 2 to 40.

5. A method for preparing a graft polymer according to claim 1, comprising a graft reaction of at least one thiol compound and at least one dithiol compound on reactive double bonds of a polymer containing conjugated diene units, the thiol compound being represented by the following formula (6):
R—(OCH₂CH₂)ₘ—SH (6)
where R is a saturated, linear or branched hydrocarbon chain, having at least 18 carbon atoms and m is an integer varying from 0 to 20,
the dithiol compound being represented by the following general formula (9):
HS—R′—SH (9)
where R′ is a hydrocarbon group, saturated or unsaturated, linear or branched, cyclic and/or aromatic, having from 2 to 40 carbon atoms.

6. The method according to claim 5, wherein the thiol compound is represented by the following general formula (7):
CₙH₂ₙ₊₁—SH (7)
where n is an integer varying from 18 to 110.

7. The method according to claim 5, wherein the thiol compound is represented by the following general formula (8):
CₙH₂ₙ₊₁—(OCH₂CH₂)ₘ—SH (8)
where n is an integer varying from 18 to 110 and m is an integer varying from 1 to claim 20.

8. The method according to claim 5, wherein the dithiol compound is represented by the following general formula (10):
HS—C_{n′}H_{2n′}SH (10)
where n′ is an integer varying from 2 to 40.

9. The method according to claim 5, wherein the molar ratio (R_{thiol/dithiol}) between the thiol compound and the dithiol compound is comprised between 10:1 and 800:1.

10. The method according to claim 5, wherein the reactive double bonds are pendant vinyl double bonds derived from 1-2 addition of conjugated diene units.

11. The method according to claim 10, wherein the polymer containing conjugated diene units has a weight content of units with pendant vinyl double bonds derived from 1-2 addition comprised between 5% and 80% relative to the polymer.

12. The method according to claim 10, wherein the molar ratio (R_{thiol/vinyl}) between the thiol compound and the unit with pendant vinyl double bonds derived from 1-2 addition is comprised between 1:10 and 10:1.

13. The method according to claim 5, wherein the polymer containing conjugated diene units results from the copolymerization of conjugated diene units and aromatic monovinyl hydrocarbon units.

14. The method according to claim 5, wherein it comprises the following successive steps:
(i) the thiol compound, dithiol compound and polymer containing conjugated diene units are mixed at a temperature comprised between 20° C. and 120° C., for a time of 10 minutes to 24 hours, the mixture being devoid of any solvent of radical initiator;
(ii) the mixture is brought to a temperature of between 80° C. and 200° C. for a time of 10 minutes to 48 hours.

15. (canceled)

16. A thermoreversibly cross-linked bitumen/polymer composition comprising at least one bitumen and at least one graft polymer, the graft polymer comprising:
a main polymer chain P containing conjugated diene units;
at least one side graft G represented by the following general formula (1):
R—(OCH₂CH₂)ₘS— (1)
where R is a saturated linear or branched hydrocarbon chain, having at least 18 carbon atoms, and m is an integer varying from 0 to 20, the graft G being linked to the main polymer chain P via the sulfur atom of formula (1); and
at least one graft G′ represented by the following general formula (4):
—S—R′—S— (4)
where R′ represents a hydrocarbon group, saturated or unsaturated, linear or branched, cyclic and/or aromatic, having from 2 to 40 carbon atoms, the graft G′ being linked to the main polymer chain P by each of the sulfur atoms of formula (4).

17. The bitumen/polymer composition according to claim 16, wherein the weight content of graft polymer relative to the bitumen is comprised between 0.1 and 30%.

18. A method for preparing a bitumen/polymer composition comprising mixing at least one bitumen and at least one graft polymer at a temperature comprised between 90° C. and 220° C. until the final thermoreversibly cross-linked bitumen/polymer composition is obtained, the graft polymer comprising:
a main polymer chain P containing conjugated diene units;
at least one side graft G represented by the following general formula (1):
R—(OCH₂CH₂)ₘ—S— (1)
where R is a saturated linear or branched hydrocarbon chain, having at least 18 carbon atoms, and m is an integer varying from 0 to 20, the graft G being linked to the main polymer chain P via the sulfur atom of formula (1); and
at least one graft G′ represented by the following general formula (4):
—S—R′—S— (4)
where R′ represents a hydrocarbon group, saturated or unsaturated, linear or branched, cyclic and/or aromatic, having from 2 to 40 carbon atoms, the graft G′ being linked to the main polymer chain P by each of the sulfur atoms of formula (4).

19. A bituminous mix comprising aggregates and a bitumen/polymer composition according to claim 16.

20. The bitumen/polymer composition according to claim 17, wherein the weight content of graft polymer relative to the bitumen is comprised between 1 and 10%.
